(19) United States
(12) Patent Application Publication
(10) Pub. No.: US 2005/0066206 A1
(43) Pub. Date: Mar. 24, 2005

(54) Storage device configuration

(76) Inventors: John Beers, Boise, ID (US); Stewart Wyatt, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/669,619

(22) Filed: Sep. 24, 2003

(51) Int. Cl. G06F 1/32

(52) U.S. Cl. 713/320

(57) ABSTRACT

Storage device configuration. A system and method are disclosed for configuring power and performance of a storage device based on the operation desired by the user. The system and method generally identify a storage device to be configured. Configuration of device parameters associated with the storage device may be determined based on the operation desired by a user. The storage device can then be configured using the determined configuration of device parameters.

### BACKGROUND

In most electronic systems and devices (collectively “device(s)” herein) there is a trade-off between power consumption and performance. Generally, to sustain a device operating at maximum performance usually requires more power than the power required for the device to operate at lower performance levels.

In storage devices (such as hard disks, memory cards, tape drives, compact disks, or any other storage device), this tradeoff between power and performance often appears in terms of speed versus power consumption. The faster the storage device is operated, the more power the device requires.

Maximum performance is usually an important priority for many electronic devices. For battery-powered devices, however, the amount of power consumed may be more important to the user than the performance or speed of the device. For example, a mobile phone user may accept lower performance in exchange for less power consumption and thus longer battery life. Or similarly, a user of a portable computer may accept slower performance in exchange for longer battery life.

A user's desired balance of the power-performance tradeoff may change depending on the circumstances. For instance, a digital camera user taking photos of fast action may desire maximum speed and performance to shoot pictures quickly to capture the action. The same user, however, may accept slower performance and may prefer reducing power consumption to extend battery life when shooting less dynamic subjects.

Given that a user's priorities may change at any time depending on the circumstances, the desired setting of a storage device's power-performance tradeoff may need to be changed as well. Setting a storage device's settings, however, may be too complicated for the normal user. Specifically, the parameters controlling a storage device's operation (such as data transfer rates, voltage levels, error checking, and other parameters) may be too complicated for the average user to interpret. Moreover the storage device parameters may be too complex for a user to make the necessary adjustments to accurately balance the desired tradeoff of performance versus power consumption for the device.

### BRIEF SUMMARY

Storage device configuration is disclosed. An embodiment of a method for configuring power and performance of a storage device identifies a storage device to be configured. Configuration of device parameters associated with the storage device may be determined based on the operation desired by a user. The storage device can be configured using the determined configuration of device parameters.

An embodiment of system for configuring power and performance of a storage device comprises a budget configuration tool coupled to the storage device. The budget configuration tool may configure the storage device by setting device parameters associated with the storage device based on the desired operation selected by a user.

### BRIEF DESCRIPTION OF THE DRAWINGS

For a detailed description of the exemplary embodiments of the invention, reference will now be made to the accompanying drawings in which:

FIG. 1 is a system diagram of an embodiment of a storage device power and performance configuration system;

FIG. 2 is a diagram illustrating an embodiment of a user interface for a storage device power and performance configuration system or method;

FIG. 3 is a flow chart illustrating an embodiment of a storage device power and performance configuration method; and

FIG. 4 is a system diagram illustrating an embodiment of a general-purpose computer system on which a storage device power and performance configuration system or method could be operated in whole or in part.

### NOTATION AND NOMENCLATURE

Certain terms are used throughout the following description and claims to refer to particular components. As one skilled in the art will appreciate, components may be referred to by different names. This document does not intend to distinguish between components that differ in name, but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical or communicative connection. Thus, if a first device couples to a second device, that connection may be through a direct connection, or through an indirect connection via other devices and connections.

### DETAILED DESCRIPTION

The following discussion is directed to various exemplary embodiments of the invention. The embodiments disclosed should not be interpreted, or otherwise used, as limiting the scope of the disclosure or claims. In addition, one skilled in the art will understand that the following description has broad application. The discussion of any embodiment is meant only to be exemplary of that embodiment and is not intended to limit the scope of the disclosure or claims to that embodiment. In this disclosure, numerous specific details may be set forth to provide a sufficient understanding of the embodiment. However, those skilled in the art will appreciate that the invention may be practiced without such specific details. In other instances, well-known elements may have been illustrated in schematic or block diagram form in order not to obscure the disclosure in unnecessary detail. Additionally, some details may have been omitted where such details were not considered necessary to obtain a complete understanding of the embodiment, and are considered to be within the understanding of persons of ordinary skill in the relevant art. It is further noted that all functions described herein may be performed in either hardware or software, or a combination thereof, unless indicated otherwise.

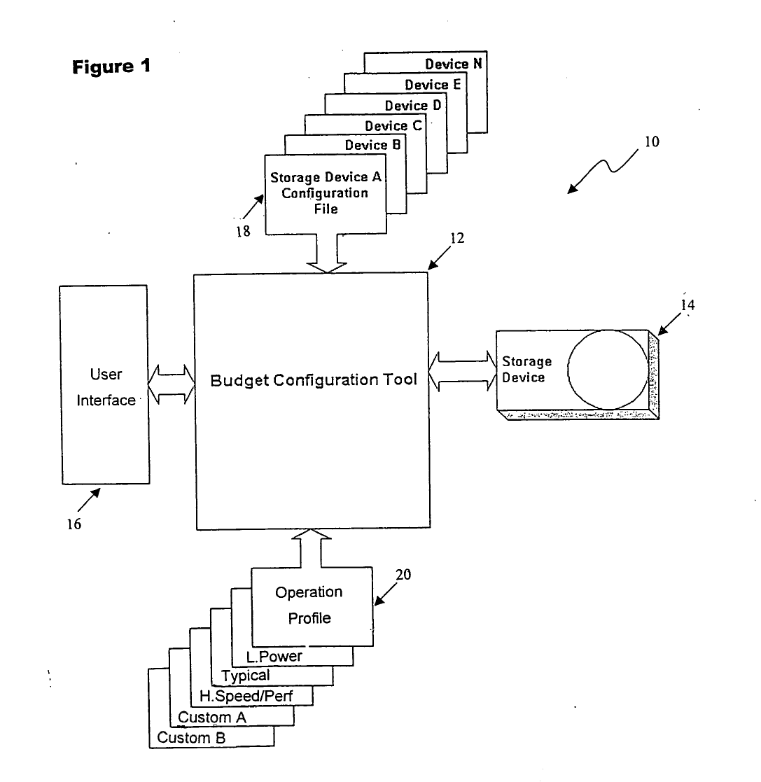

Referring initially to FIG. 1, an embodiment of a storage device power and performance configuration system 10 is shown. In this embodiment, the system 10 comprises a budget configuration tool 12 coupled to a storage device 14, a user interface 16, configuration files 18, and operation profiles 20. The budget configuration tool 12 facilitates the configuration of one or more storage devices 14 based on the operation as desired by the user. The budget configuration tool 12 enables a user to configure an electronic storage device 14 using the device's configuration parameters directly, or by using an easily understood selection format. The budget configuration tool 12 enables a user to configure an electronic storage device 14 without requiring the user to possess detailed knowledge of the storage device technology. For example, the user may select the desired operation in terms of the tradeoff between power and performance.

Modern storage devices 14 are often capable of varying modes of operation that allow differing balances to be achieved for the power and performance tradeoff. These modes of operation are typically controlled via several parameters associated with the storage device 14. With the numerous types and models of modern storage devices 14 available, and the various parameters associated with the devices, it is not practical for the user to learn the parameters necessary to configure each storage device 14 that may be coupled to the system 10. Although technically sophisticated users may be able to set the device parameters directly, all users should also be able to take advantage of the device's configuration capability to achieve a desired performance. Accordingly, the budget configuration tool 12 facilitates both technically sophisticated users and normal users configuring a storage device 14.

In the FIG. 1 embodiment of the system 10, a single storage device 14 is shown but one or more storage devices might be coupled to the system 10. The storage device 14 may be any kind of electronic storage or memory device. Storage devices 14 generally allow data or information to be stored or retrieved. Examples of storage devices 14 would include hard disk drives, tape drives, memory cards, memory sticks, compact disk drives, DVD drives, ROM or RAM. Storage devices 14 are used in almost every electronic system and device, including computers, digital cameras, PDA devices, mobile phones, audio players, and television sets, for example. Both the types of available storage devices 14 and the number of applications for storage devices 14 are increasing. Accordingly, storage device configuration described herein has broad utility and may be useful for the many devices and applications of today as well as those that may be developed in the future, particularly future storage devices that may have even more complicated configuration parameters.

As the number and complexity of the available storage devices 14 increases, so does the corresponding difficulty in configuring these devices for the operation and performance desired. Moreover, the task of configuring these devices by a user becomes increasingly daunting. The prospect of knowing what parameters are available for a given device 14, which parameters to set in order to achieve the desired performance, and how to set the parameters, can be overwhelming for the normal user.

An example of a storage device 14 and some of the parameters associated with the device, and particularly those parameters that affect the power and performance tradeoff, are as follows:
Storage Device=SanDisk™ CompactFlash™ Memory Card
Model=SDCFB-128 (128 Mb capacity)
Sleep Power Draw (3.3V)=0.2 mA
Read Power Draw (3.3V)=32 mA to 45 mA (range slow to fast—modes)
Write Power Draw (3.3V)=32 mA to 60 mA (range slow to fast—modes)
Set Sleep Mode=5 mS default (programmable)
Mode 0=3.3 Mb/s
Mode 1=5.2 Mb/s
Mode 2=8.3 Mb/s
Mode 3=11.1 Mb/s
Mode 4=16.6 Mb/s
   As indicated from the above, the storage device is a memory card of the type often used in portable devices, such as digital cameras. The card supports 5 operating modes that may be selected, Modes 0-4. The selected mode determines the speed of the card, i.e., the speed of the memory access. Mode 0 is slowest (3.3 Mb/s), Mode 4 is fastest (16.6 Mb/s). The power consumption/draw for reads and writes to and from the memory is directly dependent on the speed that the memory is operated. As illustrated, the faster the speed, the higher the power consumption/draw. While a slow read operation would only require 32 mA, a fast read would draw 45 mA. Similarly, a slow write operation would only draw 32 mA, while a fast write would require 60 mA.

A sleep mode is also provided to minimize power consumption. The time before the sleep mode is automatically initiated has a default setting of 5 mS. This setting means the card will enter sleep mode to conserve energy if inactive for 5 mS. While sleep mode may conserve power, typically going in and out of sleep mode takes time and can therefore adversely affect performance. Accordingly, to further reduce power consumption, but sacrifice performance, the time for initiation of sleep mode may be reduced so that sleep mode is more often entered. Or, to enhance performance, but correspondingly sacrifice power consumption, the time may be increased so sleep mode is rarely initiated.

One example of a relatively simple storage device 14 and its parameters has been described. Other storage devices 14 may have more or less parameters some of which may or may not be similar to those described in this example. Examples of other storage device parameters include voltage levels, data transfer rates, and error checking. Additionally, even parameters that may be similarly named may have very different functions, and may have to be set very differently to achieve the desired performance. Moreover, different methods or techniques may be required to set or modify the parameters. Thus, a user would need to know the types of parameters available for the storage device 14, what values to set the parameters to in order to achieve the desired performance for the subject storage device 14, and how to set the parameters for that specific device 14.

Given the numerosity and variability of available parameters, the identity of the parameters for a storage device 14 and related information may be saved in a configuration file 18. In the embodiment of the system 10 as shown in FIG. 1, configuration files 18 exist for multiple storage devices 14 so that the parameters for any storage device 14 coupled to the system 10 may be available via a configuration file 18. Of course as new storage devices 14 are developed, new configuration files 18 may have to be added. Accordingly, as the parameters or information relating to the operation of the storage devices 14 change, the configuration files 18 may have to be modified or replaced to ensure the parameters and operational information for the devices are current and accurate.

Although the configuration files 18 are shown as a part of the system 10, other ways exist to access the device parameters and operational information in a configuration file 18. For example, the configuration file 18 may be stored locally in the system 10 or stored remotely on another system that might be accessible via the Internet or other network connection. Such a remote configuration file 18 could be accessed by downloading the information to the system 10 when a new storage device is coupled to the system 10, or when the system 10 attempts to configure a storage device 14 for which there is not yet a configuration file 18 in the system 10. Additionally, the configuration file 18 may be stored in the storage device 14. The information could then be accessed from the storage device 14 and allow the storage device 14 to provide the configuration information necessary to configure itself.

An operation profile 20 may store certain operational states or settings for the storage device 14 or system 10. For example, there may be a setting for the system 10 that balances power consumption and performance at a default level to support normal operation of the system. Such a default setting could be saved as an operation profile 20. Two other likely settings are maximizing the performance of the system or minimizing the power consumption. Accordingly, a low power operation profile 20 may be saved for operation that sacrifices performance for low power consumption. For example, the storage device may be operated at slower speeds to conserve power. Similarly, a high performance operation profile 20 may be provided for operation that maximizes operational performance regardless of power consumption. The operation profile 20, then, can be used to store various operational settings or balances of the power and performance tradeoff.

In the embodiment of FIG. 1, the user may select the operation desired via the power and performance tradeoff using the operation profiles 20. Other simplified presentations of the power and performance tradeoff, however, may be presented to the user for selection of the desired operation. For example, the user might select the desired operation via a graphical illustration of the desired operation. For instance, the user might select the desired performance via a budget gauge. A budget gauge may be any graphical representation of the “give-and-take” relationship that usually exists between power and performance. For example, the budget gauge could be a pie chart, bar chart, or other visual representation of the power and performance tradeoff. Whether by a graphical illustration (such as a budget gauge), a list of operation profiles 18, or a combination thereof, the system 10 may present options to the user for selection via a user interface 16. The user may set the desired operation by selecting from options presented on the user interface 16. Alternatively, the user may set the desired operation by manipulating the graphic illustration directly, for instance, by moving a boundary on a bar chart or pie chart (or other budget gauge graphic) to modify the tradeoff between power and performance.

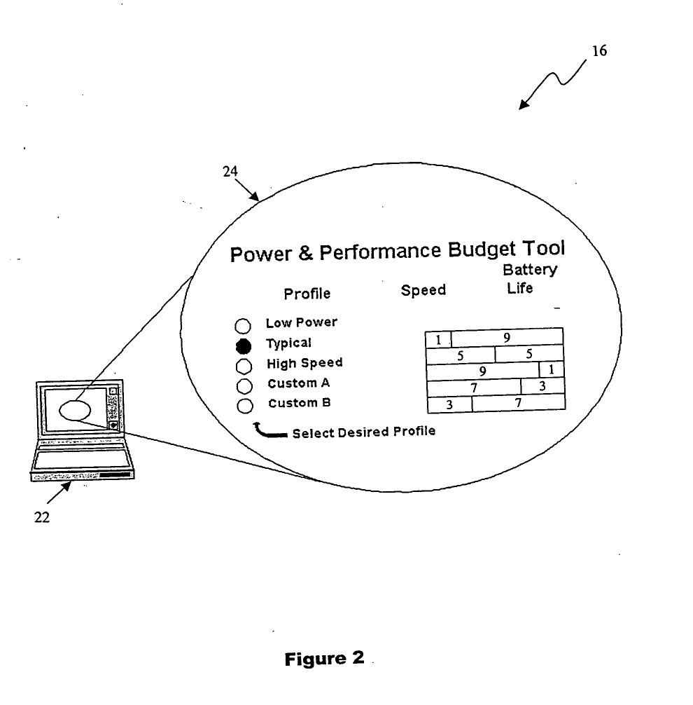

The user interface 16 allows the user to input the desired operation for the system 10 or the storage device 14. The user interface may present simple selections to assist the user in selecting the desired operation. In addition, the user interface 16 may display the currently pending state or operating mode. An example of one embodiment of a user interface is shown in FIG. 2.

FIG. 2 is an illustration of an embodiment of a user interface 16 for a storage device power and performance configuration system or method. In the embodiment of FIG. 2, the user interface 16 is presented to the user on the screen of a portable computer 22. The user interface 16 could also be presented on the screens of other electronic devices such as a digital camera or mpeg player, for example. Blowup 24 of the screen shows an embodiment of the user interface 16 as presented to the user. Generally, this user interface 16 would be available when the power and performance configuration system or method is operating. This embodiment of the user interface 16 presents a title “Power & Performance Budget Tool.” Under the title, there are three headers: Profile, Speed, and Battery Life. Under the Profile header, five profiles are presented with a selection button next to each profile. The profiles shown are Low Power, Typical, High Speed, Custom A, and Custom B. Beneath the Speed and Battery Life headers, the user is presented with a graphic illustration showing the tradeoff between Speed (i.e., performance) and Battery Life (i.e., power consumption) for each of the available Profiles. In this embodiment, the graphic illustration of the information is presented as bar charts or scales, with numbers embedded therein representing a scale from 1-10. The charts and number scales indicate the tradeoff between power and performance, or more specifically in this case between Speed and Battery Life. The graphic illustrates the resulting balance between Speed and Battery Life depending on which Profile is selected. The graphic does not show the user the device parameter settings in order to achieve the selected operation. Rather, the graphic simplifies the presentation by providing a demonstrative illustration of the resulting operation depending on which Profile is selected.

As shown in FIG. 2, the Low Power profile corresponds to a Speed rating of 1 and a Battery Life rating of 9. This profile places a premium on power conservation at the expense of performance. The Typical profile corresponds to a Speed rating of 5 and a Battery Life rating of 5 and provides an equal balance between power and performance. The High Speed profile corresponds to a Speed rating of 9 and a Battery Life rating of 1. This profile places a premium on performance at the expense of power consumption. Custom profiles, Custom A and Custom B, are available for selection as well. These profiles may represent manual settings of the operation that have been saved by the user. Alternatively, these custom profiles also could be an operation profile that has been predetermined, by the user or by other means. In this embodiment, the Custom A profile corresponds to a Speed rating of 7 and a Battery Life rating of 3. The Custom A profile therefore provides some preference for speed and performance over power conservation and battery life. This profile though does not have as stark an imbalance as the High Speed profile. The Custom B profile, on the other hand, corresponds to a Speed rating of 3 and a Battery Life rating of 7. The Custom B profile therefore provides some preference for power conservation and battery life over speed and performance. This profile is not as stark an imbalance as the Low Power profile.

The custom profiles may also represent operational settings achieved via the user manually setting the device parameters and then saving those settings as a custom profile. The custom profile could provide a link that would take the user to another screen showing the device parameters and allowing the user to set them directly. Once the parameters are set, the user may be presented with an option to save the settings as a new custom profile. Thus, the custom profiles could allow sophisticated users to set the parameters directly and to save those settings for easy reuse later. These profiles can also provide a simplified method to set the desired operation for normal users.

The FIG. 2 embodiment of the user interface 16 contemplates a windows-like environment where the user is prompted to select the desired profile corresponding to the user's desired operation. The user would then make the desired selection via the buttons next to each profile. The shaded button indicates which profile is presently activated, and thus which operation level is active. As shown in FIG. 2, the Typical operation profile is active. As a result, the user interface 16 provides a normal user with an easy way to select desired operation of the system and also provides an indication of the effects of the available selections on the power and performance tradeoff. Moreover, the user interface 16 does not require the user to understand what parameters must be set for the specific storage device in order to correspond to the desired operation. The interface also does not require the user to understand how to set those parameters. The user is provided the opportunity to make an educated decision about system operation without having to understand the more technical aspects of the storage device or its parameters. In addition, the user interface 16 can also facilitate sophisticated users via the custom profiles.

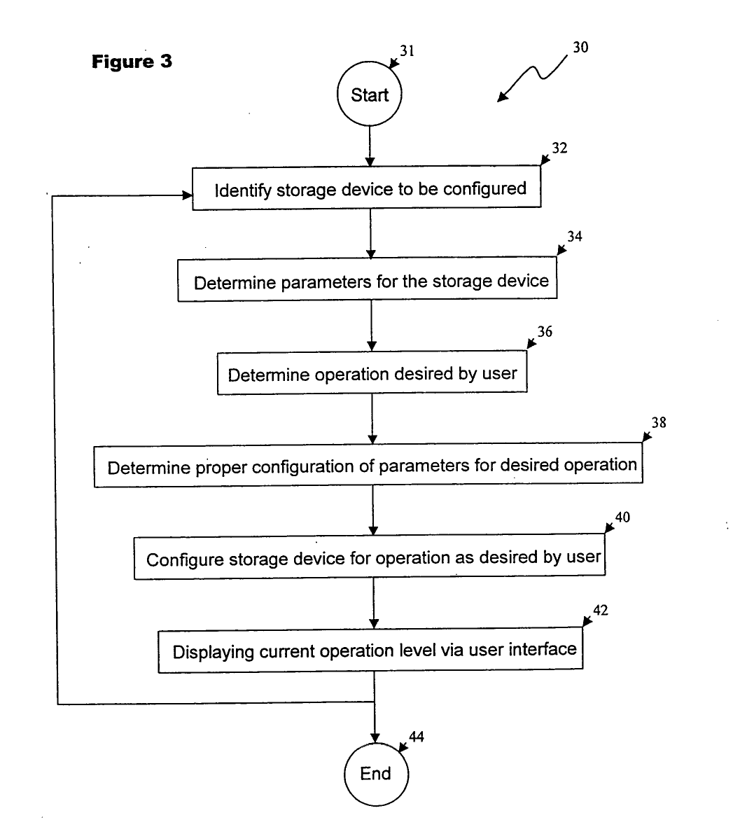

FIG. 3 presents a flow chart illustrating an embodiment of a storage device power and performance configuration method 30. The configuration method 30 starts at 31. Once the configuration method 30 is initiated, the storage device to be configured is identified in box 32. If there is a single storage device coupled to the system then the identification process requires few steps. If multiple storage devices are coupled to the system, however, this embodiment of the method 30 will identify all storage devices in the system and then present these devices to the user for selection of the storage device to be configured via a user interface. Once the device to be configured has been determined, the parameters for configuring the storage device are determined in box 34. These parameters and other information relating to the configuration of a storage device can be stored in configuration files. Accordingly, a configuration profile may be accessed in order to obtain the necessary information regarding the configuration parameters for the device. This information may include the identity of the parameters as well as how to set the parameters to configure the device. The configuration file may be local or remote to the system. In box 36, the operation desired by the user is determined. In this embodiment of the method 30, the user selects the desired operation via a user interface. The various operational settings may be presented to the user as operation profiles, graphic illustrations, combinations thereof, or other ways to simplify the selection process for the normal user. The presentation to the user may be simplified by presenting the operational selections in terms of the power and performance tradeoff. The user may select the desired operation by selecting an operation profile, manipulating a graphic illustration such as a budget gauge, or by other selection means. The operation profiles may be local or remote. As discussed herein, embodiments of the configuration method may also allow technically sophisticated users to set the parameters directly, and to save those settings as a custom operation profile. In box 38, the proper configuration of the parameters to achieve the desired operation is determined. In this embodiment, the method 30 uses the parameters and other configuration information relating to the storage device to determine how to configure the storage device for operation as desired by the user. When this determination is made, the storage device is configured for the desired operation in box 40. Once the current operation level has been set, it can then be displayed via the user interface in box 42. If another storage device is to be configured or if the user's desired operation changes, the configuration method can be repeated by returning to box 32, or the process can end at 44.

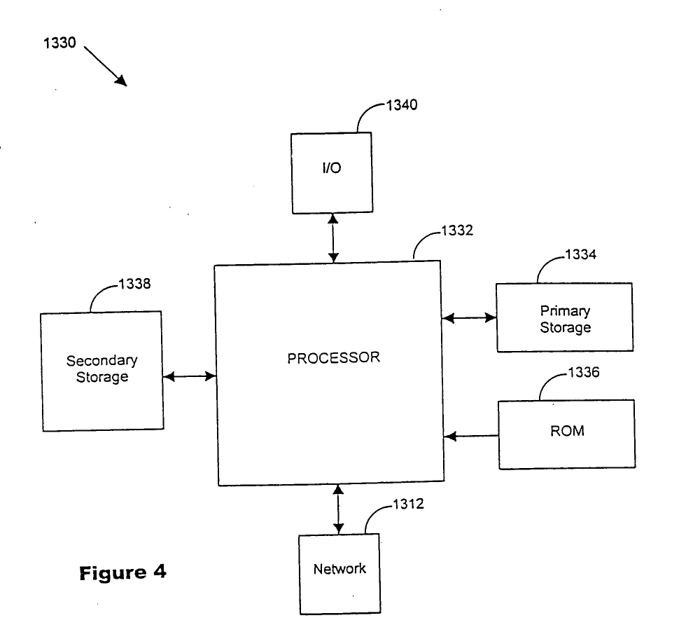

FIG. 4 is a system diagram illustrating an embodiment of a general-purpose computer system on which a storage device power and performance configuration system or method could be operated in whole or in part. The system and method for configuring power and performance of a storage device as described herein may be implemented in whole or in part on a variety of different computer systems. FIG. 4 illustrates on such general-purpose computer system. The computer system 1330 includes a processor 1332 (also referred to as a central processing unit, or CPU) that is coupled to memory devices including primary storage devices 1336 (such as a read only memory, or ROM) and primary storage devices 1334 (such as a random access memory, or RAM).

Generally, ROM transfers data and instructions unidirectionally to CPU 1332, while RAM transfers data and instructions in a bi-directional manner. Both storage devices 1334, 1336 may include any suitable computer-readable media. A secondary storage medium 1338, such as a mass memory device, is also coupled bi-directionally to CPU 1332 and provides additional data storage capacity. The mass memory device 1338 is a computer-readable medium that may be used to store programs including computer code, data, and the like. Mass memory device 1338 is typically a storage medium utilizing a non-volatile memory that is generally slower than primary storage devices 1334, 1336, such as a hard disk or a tape. Mass memory storage device 1338 may take the form of a magnetic or paper tape reader or other known devices. In appropriate cases, the information retained within the mass memory device 1338 may be incorporated as part of RAM 1336 as virtual memory. A specific primary storage device 1334 such as a CD-ROM may also pass data to the CPU 1332.

CPU 1332 also couples to one or more input/output devices 1340 that may include devices such as video monitors, track balls, mice, keyboards, microphones, touch-sensitive displays, transducer card readers, magnetic or paper tape readers, tablets, styluses, voice or handwriting recognizers, or other known input/output devices, including other computers. Finally, CPU 1332 optionally may be coupled to a computer or telecommunications network, e.g., an Internet network, or an intranet network, using a network connection as shown generally at 1312. With such a network connection, CPU 1332 may receive information from the network, or may output information to the network in the course of performing the processes and methods in accordance with the disclosure herein. Such information is often represented as a sequence of instructions to be executed using CPU 1332. The information may be received from and outputted to the network in the form of a computer data signal embodied in a carrier wave.

In one embodiment, sequences of instructions may be executed substantially simultaneously on multiple CPUs, as for example a CPU in communication across network connections. Specifically, the above-described process may be performed across a computer network. Additionally, it will be recognized by one of skill in the art that the process may be recognized as sets of computer codes and that such computer codes can be stored in computer readable media such as RAM, ROM, hard discs, floppy discs, carrier waves, or other media.

The above discussion is meant to be illustrative of the principles and various embodiments of the present invention. Numerous variations and modifications will become apparent to those skilled in the art once the above disclosure is fully appreciated. For example, the system and method for configuring power and performance of storage devices may at times incorporate more or less components or functions than the embodiments described herein. This disclosure makes those principles and modified embodiments apparent to those skilled in the art. It is intended that the following claims be interpreted to embrace all such variations and modifications.

1. A method for configuring power consumption and performance of a storage device, comprising:
providing an electronic storage device with an operational profile comprising at least two different settings to regulate power consumption and performance of the storage device;
displaying via a graphical illustration the operational profile and each of the two different settings for power consumption and performance of the storage device; and
selecting one of the two different settings to configure power consumption and performance of the storage device.

2. The method of claim 1 further comprising selecting a first one of the two settings to increase performance of the storage device and to increase power consumption of the electronic device.

3. The method of claim 1 further comprising selecting a second one of the two settings to decrease performance of the storage device and to decrease power consumption of the electronic device.

4. The method of claim 1 wherein displaying via a graphical illustration comprises showing a tradeoff between performance and power consumption for the storage device.

5. The method of claim 4 wherein displaying via a graphical illustration comprises presenting bar charts to show the tradeoff between performance and power consumption.

6. The method of claim 1 further comprising:
providing the storage device with the operational profile comprising three different settings to regulate power consumption and performance of the storage device, wherein a first setting has a low power consumption and a low performance, a second setting has a medium power consumption and a medium performance, and a third setting has a high power consumption and a high performance; and
displaying via the graphical illustration the operational profile and each of the three different settings for power consumption and performance of the storage device.

7. The method of claim 1 wherein selecting one of the two settings comprises enabling a user to enter an input to the storage device to configure the storage device to one of the two settings and alter power consumption and performance of the storage device.

8. The method of claim 7 further comprising enabling the user to enter the input directly via a user interface and to save the operational profile to one of the two settings.

9. A system for configuring power and performance of a storage device, comprising:
a storage device to be configured; and
a budget configuration tool coupled to the storage device wherein the budget configuration tool configures the power and performance of the storage device by setting device parameters associated with the storage device based on desired operation as selected by a user.

10. The system of claim 9 wherein the user selects the desired operation in terms of a power and performance tradeoff.

11. The system of claim 9 further comprising a configuration file that can be accessed by the budget configuration tool, wherein the configuration file comprises information regarding device parameters associated with the storage device and an effect of setting the device parameters on the power and performance of the storage device.

12. The system of claim 9 further comprising at least one operation profile that can be accessed by the budget configuration tool, each operation profile corresponding to an operating mode of the storage device.

13. The system of claim 9 further comprising a user interface where the user can select the desired operation of the system for use by the budget configuration tool.

14. The system of claim 13 wherein a plurality of operation profiles is presented via the user interface for the user to select the desired operation.

15. The system of claim 14 wherein the plurality of operation profiles is presented in terms of power and performance tradeoff.

16. The system of claim 13 wherein the user interface presents a graphic illustration of the power and performance tradeoff of the operation selected by the user.

17. The system of claim 16 wherein the user can select the desired operation via the graphic illustration.

18. A system for configuring power and performance of a storage device, comprising:
means for assisting a user in selecting a desired operation for a storage device based on the power and performance of the storage device; and
means for configuring the storage device for operation as desired by the user.

19. The system of claim 18 further comprising means for a user to select a desired operating mode for a storage device from a plurality of operating modes for the storage device, wherein a selected operating mode corresponds to a desired operation of a storage device based on power consumption and performance of the storage device.

20. The system of claim 18 further comprising means for accessing information regarding device parameters associated with the storage device and how to set the device parameters for the desired operation of the storage device.
